(19) United States
(12) Patent Application Publication
(10) Pub. No.: US 2020/0170224 A1
(43) Pub. Date: Jun. 4, 2020

(54) APPARATUS AND METHOD FOR PRODUCING AND MAINTAINING HYGIENIC DRINKING WATER WITHIN A POULTRY / ANIMAL HUSBANDRY FACILITY

(71) Applicant: Poultry EcoServices, LLC, Annapolis, MD (US)

(72) Inventor: Rafael Sepulveda CORREA, Berlin, MD (US)

(21) Appl. No.: 16/787,120

(22) Filed: Feb. 11, 2020

Related U.S. Application Data
(63) Continuation-in-part of application No. 16/196,334, filed on Nov. 20, 2018.

(51) Int. Cl. A01K 39/02; C02F 9/00; A01K 7/02

(52) U.S. Cl. CPC A01K 39/0213; C02F 1/78; A01K 7/025; C02F 9/00

(57) ABSTRACT

A method and apparatus for delivering sanitized drinking water to a poultry or other animal husbandry facility with water supplied from either a potable or non-potable source. In the case of a non-potable water source, ozone and antimicrobial copper or copper alloy are employed as primary and secondary sanitizing agents to eliminate chemical and biological drinking water contaminants. Ozone gas is generated onsite and serves as the primary sanitation agent prior to distribution of water to nipple drinker conduits within the facility. In the case of a potable water source, water is delivered directly to the drinking water distribution system. In either case, at least one conduit is filled with a woven mesh of antimicrobial copper to perform as a passive sanitation agent to inhibit microbial propagation and prevent development of biofilm within a nipple drinker system during periods of low flow and high temperatures. In the case of non-potable water source, as animals mature and consume more water, increasing concentrations of residual ozone clean the copper/copper alloy mesh surface and sanitize exposed nipple drinker actuator pins.

### CROSS-REFERENCE TO EARLIER APPLICATION

This application is a Continuation-in-Part of application Ser. No. 16/196,334 filed Nov. 20, 2018. The entire content of application Ser. No. 16/196,334 is incorporated herein by reference.

### BACKGROUND OF THE INVENTION

With increased consumer and regulatory demand for antibiotic-free food animal production, poultry producers face new challenges to maintain flock viability and remain commercially competitive. These challenges include control of housing unit environmental conditions, litter quality, feed quality and, especially, water quality. Variations in temperature and humidity can heighten these challenges.

The drinking water supply in a typical broiler poultry housing unit is affected by multiple challenges that are shared in part by other food animal operations. Nipple drinkers are used in poultry/animal husbandry to eliminate direct exposure of drinking water to airborne flies, mosquitos and their larvae, dust, dander and feathers. Drinking water is sometimes supplied from a potable water source; however, more often it is sourced from a local subterranean aquifer with limited monitoring and sanitizing treatment and is likely to contain bacteria, viruses, algae, dissolved nutrients, iron and other minerals. Regardless of the source, under low flow and elevated temperature conditions prevalent within poultry houses, there is a high potential for the presence of water-borne chemical and biological contaminants within water lines to which nipple drinkers are attached. The nipple drinkers themselves allow direct contact cross contamination and provide a pathway for pathogens to enter drinking water supply lines,

Slow laminar flow within long water supply lines that are exposed to poultry house radiant heating and heat transfer from warm ambient air provide conditions most suitable for microbial propagation. Iron oxidizing bacteria (FeOB) and other bacteria colonies attach to supply line walls, creating a sticky gelatinous membrane called biofilm.

A layout period of two weeks or more preceding placement of a new flock is typical as a method to reduce pathogens within the litter. During this time, while water supply lines are raised to the chicken house rafters, where temperatures are highest, pockets of stagnant water within the supply lines provide conditions that maximize potential for biofilm development.

Due to the endothermic characteristic of poultry hatchlings, commercial grow houses are preheated (96-98° F.; 35.5-36.7° C.) for a period of one or more days prior to placement of new flock. During the preheat period, conditions within the supply lines exacerbate potential for microbial propagation and biofilm development. This leads to the compromise of drinking water hygiene when the newly placed flock is most vulnerable. This high-risk combination persists during the first two weeks of the flock brooding period. Adverse health effects that develop during this period influence performance outcomes as flocks mature.

Water consumption of newborn chicks is only 65 liters per 24 hours per 1000 chicks. Within a commercial poultry housing unit, this volume is typically divided into 24 water lines, each 50 feet long, resulting in sustained near-stagnant flow conditions.

As chicks develop, water consumption increases. By the end of second week, water consumption is doubled. Increase in water flow causes biofilm formed during the near-stagnant periods to break loose and begin to cause bird health issues.

The effects of biofilm development are numerous.

Pathogenic microbes thrive and colonize in the biofilm due to high moisture and temperature conditions. As a result, hygienic water dispensed within a poultry house can become contaminated before reaching the flock. These pathogens can spread diseases that severely challenge the health, welfare and commercial performance of the flock.

Poultry ingestion of biofilm contaminated water can cause multiple digestive system problems that hinder growth and cause watery feces (diarrhea). The wet and contaminated feces, now resident on the poultry house floor, spreads disease to other birds within the poultry house, diminishing the health and welfare of the flock.

As biofilm accumulates, segments become detached and are carried into nipple drinkers, causing failure, either by flow blockage or by preventing nipple drinker valve sealing. In addition to impacting poultry nourishment due to inadequate drinking water delivery, leaks from improperly functioning nipple drinkers can contribute to a multitude of environmental and animal welfare problems associated with high moisture in poultry house litter.

Wet litter produces ammonia, causing physical stress to birds and reducing feed conversion efficiency. Increased floor moisture also causes foot pad or paw dermatitis, providing a pathway for intrusion and spread of pathogens within a chicken's anatomy, degrading a flock's welfare and reducing its commercial value.

Individual nipple drinker devices are shared by multiple birds creating another source of cross-contamination. Depending upon the species, growth stage, temperature, ventilation, poultry house size and other factors, the typical configuration provides one nipple drinker per 8-30 birds. During a flock grow-out period, nipple drinker external surfaces, including the actuator pin, are exposed to an environment of moisture, elevated temperatures, feces dust and nutrients that promote microbial propagation. Unfortunately, deteriorating conditions are not readily visible to a flock's caretaker and are, therefore, typically addressed when time is available, or after a flock's health, welfare and performance have been impacted.

Techniques for managing a flock's health include regular flushing of water lines. Flushing not only helps to remove debris and particulate matter from water supply lines, it also helps to introduce cooler water into the system. While flushing can be performed regularly, such methods are limited in practice due to associated labor, equipment and maintenance costs.

While the incorporation of antibiotics in poultry feed minimizes the negative effects of water contamination, increased consumer and regulatory demand for antibiotic free production discourages or prohibits continuation of this practice. There is, therefore, a need for alternative solutions to the drinking water challenges faced by the commercial poultry industry.

Current poultry/animal watering system cleaning methods include the use of chemicals to flush water lines and do not adequately address all the above-mentioned problems. Moreover, these methods are always performed after flock performance has been impacted since regulations of the United States Environmental Protection Agency (EPA) restrict use of cleaning chemicals during a flock grow-out period.

Copper has been used for thousands of years for medicinal purposes and to sterilize drinking water. The use of copper as a primary antimicrobial agent continued until the advent of commercially available antibiotics in 1932. Widespread and often indiscriminate usage of antibiotics soon led to development of antibiotic resistant microbes. Today, antibiotic resistant pathogens are ubiquitous in hospitals, nursing homes, food processing plants and animal husbandry facilities. Antibiotic resistance has caused renewed interest in the use of copper in hygiene-sensitive areas. In 2008, copper became the only solid metal antimicrobial touch surface approved for registration by the EPA. Currently, there are over 500 copper compositions that are registered as EPA-approved antimicrobial copper alloys. Research has shown that the “contact killing” efficacy of antibiotic copper increases with higher copper content of alloys, higher temperature and relative humidity environments. Copper's contact killing efficacy is much greater for dry surfaces than for wet surfaces.

Antimicrobial copper is capable of destroying a wide range of microorganisms including for example, E. coli 0157:H7, methicillin-resistant Staphylococcus aureus (MRSA), Staphylococcus, Clostridium difficile, influenza A virus, Adenovirus and fungi.

Ozone is a powerful antimicrobial oxidizer and sanitizer and is widely used as a primary disinfectant in combination with secondary chlorine sanitizers in commercial and municipal water treatment applications. Ozone gas is readily dissolved in water to create aqueous ozone, an effective antimicrobial agent. The disinfecting capability of 1 ppm aqueous ozone is equivalent to 10 to 4,000 times higher concentrations of available free chlorine (FAC), depending on pH, temperature and concentrations of specific microorganisms to be destroyed.

In 1976, the EPA approved ozone as an antimicrobial oxidizer. In 1999 EPA listed ozone as safe for surface and groundwater. The U.S. Food and Drug Administration (FDA) and the U.S. Department of Agriculture (USDA) approved ozone as an antimicrobial food additive and food surface disinfectant in 2001. Ozone was added to the FDA Model Food Code in 2010. Ozone is not harmful to humans; no U.S. Occupational Safety and Health Administration (OSHA) regulations apply to aqueous ozone.

### SUMMARY OF THE INVENTION

In accordance with various embodiments, an apparatus and method for supplying hygienic drinking water for a commercial poultry/animal husbandry facility are employed to take advantage of the antimicrobial properties of copper and the oxidizing potential of aqueous ozone, both of which function as effective water sanitizing agents.

Embodiments of the present disclosure provide improvements to drinking water systems commonly found within poultry/animal husbandry facilities. Where drinking water is supplied from a well or other non-potable source, ozone pre-treatment eliminates biological and chemical contaminants prior to dispersal to nipple drinkers. The hygiene of water that has been pretreated or supplied from a potable water source, is maintained by antimicrobial copper mesh inserted into water distribution and supply lines preventing pathogen propagation and biofilm formation. These features are implemented in a manner consistent with the highly variable conditions of a poultry house environment and allow poultry producers to maximize the use of existing equipment.

### BRIEF DESCRIPTION OF THE DRAWINGS

Other aspects, features and advantages of the disclosure will become apparent from a study of the following description when viewed in the light of the accompanying drawings, in which:

FIG. 1 is a schematic diagram of an assembly for producing and maintaining hygienic drinking water within a poultry husbandry facility, whether supplied from a potable or non-potable water source;

FIG. 2 is a partial schematic view of the assembly of FIG. 1 including an enlarged view of a poultry nipple drinker supply line;

FIG. 3 is perspective sectional view of a nipple drinker water supply line including a pathogen inhibiting material arranged therein;

FIG. 4 is a cross-section of the embodiment of FIG. 3 taken along line 4-4;

FIG. 5 is a cross-section of the embodiment of FIG. 4 taken along line 5-5; and

FIG. 6 is a flow chart of a method for maintaining a hygienic drinking water supply in a poultry/animal husbandry facility, whether supplied from a potable or non-potable water source.

### DETAILED DESCRIPTION

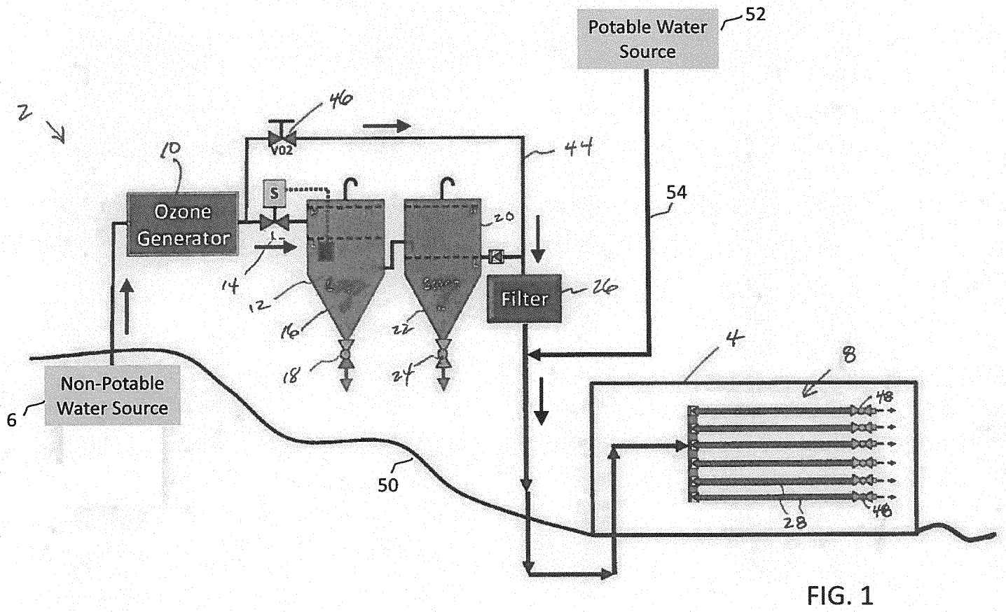

An apparatus 2 for producing and maintaining hygienic drinking water within a poultry/animal husbandry facility 4 is illustrated at FIG. 1. Water is drawn from a well or other pressurized non-potable water source 6 or a potable water source 52 and delivered to a nipple drinker from which water is dispensed to a poultry flock within the facility.

In accordance with various aspects, ozone gas is produced by an ozone generator 10 and injected into water drawn from the non-potable water supply source. Ozonating sanitizes the water by precipitating dissolved metals and destroying pathogenic bacteria prior to delivering the water to the poultry facility 4. In accordance with various aspects, operation of the ozone generator 10 is adjusted to achieve ozone concentrations from 4 to 8 ppm.

In a first mode of operation with a non-potable water source 6, ozonated water is collected and temporarily stored in a first reaction tank 12. A solenoid valve 14 is operable to maintain a desired water level within the first reaction tank. The solenoid valve 14 may be activated by a mechanical float or electronic water level switch device. The tank is preferably vented so that the water is maintained at atmospheric pressure.

To achieve effective oxidation within the first reaction tank 12, the required ozone concentration is adjusted according to biological and chemical contaminant loading of the site-specific non-potable water supply 6 and mode of operation.

Upon reaching the desired water level, quiescent conditions within the first reaction tank 12 allow effective oxidation of dissolved metals and destruction of bacteria, viruses, mold, algae and hydrocarbon compounds. Oxidation precipitates then settle to a bottom section 16 of the tank 12 and are removed from the system through at least one of a manual or automatic and programable drain valve 18. In accordance with various aspects, the reaction tank 12 may have a frustoconical configuration, or any other suitable configuration for accumulation and removal of accumulated precipitates.

Hydrostatic equalization causes ozonated water to flow from the first reaction tank 12 to a second reaction tank 20 where additional oxidation and precipitation of solids and contaminates occurs. The precipitates collect in the bottom 22 of the tank 20 for removal via a valve 24. While FIG. 1 illustrates the use of two reaction tanks, those skilled in the art will appreciate that a single reaction tank or a plurality of reaction tanks may be employed to achieve that desired sanitation.

Hydrostatic pressure within the second reaction tank 20 causes ozonated water to flow from the second reaction tank 20 through an inline filter 26 for removal of residual suspended solids and dissolved disinfection byproducts. Sanitized and filtered water then flows to the poultry facility 4 where it is delivered to the nipple drinker assembly 8.

In a second embodiment, water from a potable source 52 is supplied directly to the poultry facility 4, where it is delivered to the nipple drinker assembly 8.

In the case of water supplied from a non-potable source 6, as water consumption increases with flock growth, increasing water flow velocities deliver higher concentrations of residual ozone to maintain the cleanliness of the nipple drinker 8 and sanitize the exposed surface of the actuator pin 40.

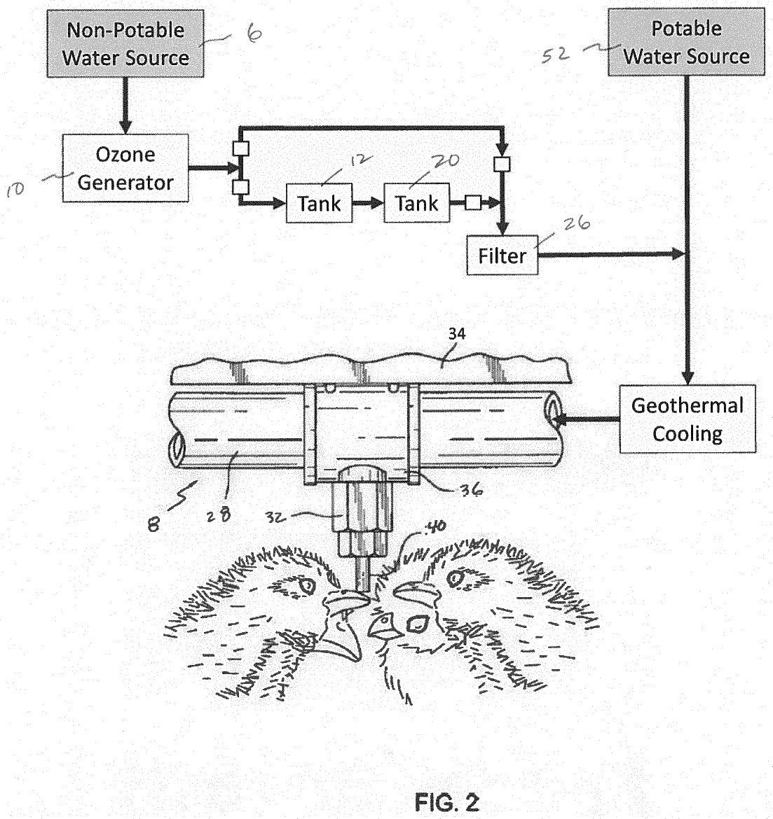

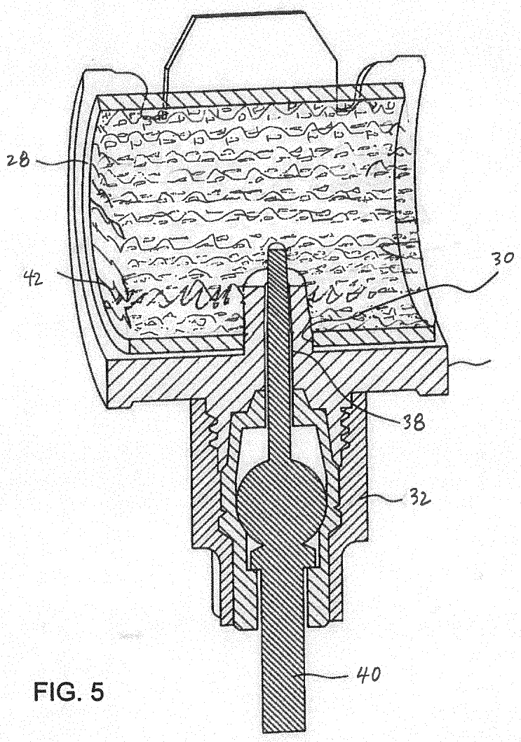

Referring now to FIGS. 2-5, the nipple drinker assembly 8 includes one or more water supply pipes or conduits 28, each of which include a plurality of perforations 30 for receiving a plurality of nipple assemblies 32, respectively. The nipple assemblies are typically spaced on 8-inch (20.32 cm) centers, and the conduits extend approximately 100 feet to 150 feet (30.48 m to 45.72 m) in length. The conduits are typically constructed from polyvinyl chloride (PVC) and/or chlorinated polyvinyl chloride (CPVC) and are attached to a suspension system 34, typically an aluminum extrusion that provides rigidity and a mechanism for suspending the supply lines or conduits 28 at variable heights according to poultry size.

The water supply conduits contain perforations 30 and support a saddle 36 for either permanently or removably connecting a nipple assembly 32 to the conduit 28. Where a saddle 36 is not used, a nipple assembly 32 is connected directly to a water supply conduit. In use, the perforation 30 is aligned with a through opening in the nipple assembly so that water can flow from the water conduit through the nipple assembly 32 and to the flock.

Nipple assemblies 32 include a valve mechanism 38 for regulating water flow. In use, a bird contacts an actuator pin, trigger or tip 40 descending from the nipple assembly, breaking the water seal within the nipple assembly, thereby releasing regulated water droplets directly to a bird or birds and minimizing overspill which can cause moisture accumulation on a poultry facility floor.

According to industry standards, the internal components of nipple drinkers are constructed from stainless steel components or from a combination of stainless steel and synthetic plastic components, for example PCV and CPVC.

To reduce biofilm buildup and exposure to water borne pathogens, one or more components of the nipple drinker may be manufactured from or plated with a pathogen-inhibiting or antimicrobial material.

According to a preferred embodiment, the pathogen inhibiting material is solid copper, copper alloy or a copper plated material.

Various forms of the pathogen inhibiting material may be introduced into a nipple drinker conduit. Such forms can include a length of wire, rod, ribbon, sheeting, coil, mesh, screen or the like arranged within the length of a nipple drinker conduit.

The larger the surface area of the pathogen inhibiting material, the greater its effectiveness in destroying or inhibiting propagation of pathogens.

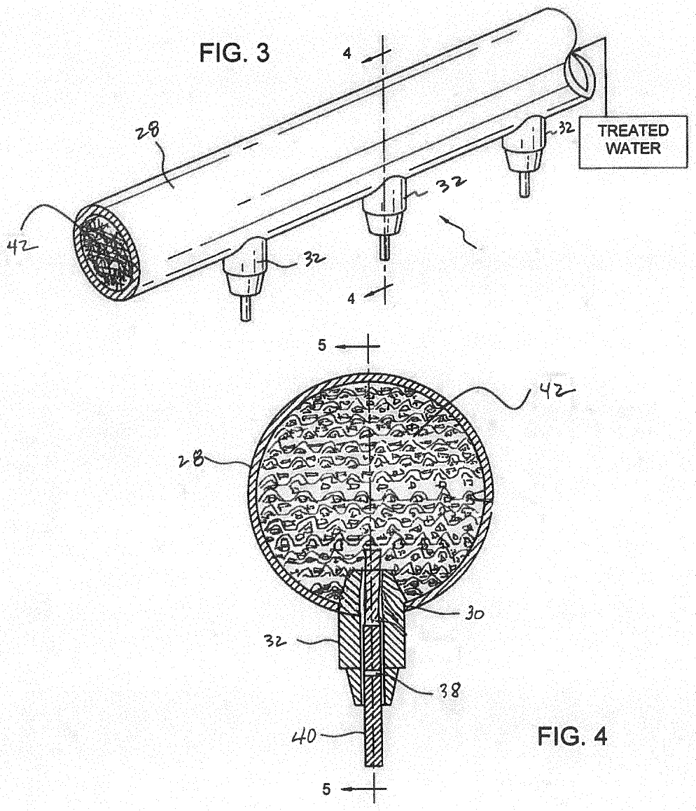

According to a preferred embodiment shown in FIGS. 3-4, a mesh 42 of pathogen inhibiting or antimicrobial material is introduced into the nipple drinker conduit 28 to inhibit the formation of biofilm and pathogen propagation during low flow/high temperature inter-flock layout and periods. In accordance with the preferred embodiment, the mesh 24 is an engineered copper mesh. It preferably extends along the length of the conduit and across the interior diameter thereof.

The mesh 42 is loosely packed such that the nipple drinker conduit cross-sectional area is substantially filled, yet water flow is unrestricted. The mesh 42 preferably has a surface area that is greater than a surface area of an interior surface of the nipple drinker conduit 28. In an alternate embodiment, the surface area of the mesh 42 may be more than seven-and-one-half times greater than the surface area of the interior surface of the nipple drinker conduit 28.

Cross-sectional fill of the conduit ensures that the mesh 42 surface contacts the entire water flow stream and creates a gentle mixing effect as water courses through the mesh.

An important aspect of the invention is that the mesh 42 may be inserted (retro-fitted) into an existing nipple drinker system to maximize usage of existing poultry house equipment. Furthermore, current techniques for using drinking water systems for delivery of flock vitamin, mineral and nutritional supplements can be maintained. Accordingly, flock dietary plans and health maintenance techniques need not be modified. The addition of mesh to the nipple drinker conduits will neither obstruct nor impede a flow of water to or within the nipple assembly 32.

At the end of a grow-out period, the flock is removed from the poultry housing facility 4, the water supply is turned off, water is drained from the nipple drinker conduits 28 and he nipple drinker conduits 28 are raised close to the ceiling. Pockets of static water may remain within the conduits due to minor variations in conduit elevation. When raised close to the ceiling of a poultry facility, the conduits can be exposed to elevated temperatures for a period of two to three weeks, ample time for pathogen propagation and biofilm development.

During this period, the actuator tips 40 of the nipple drinkers 32 (with which birds must make contact in order to drink) are exposed to copious amounts of feces dust produced during inter-flock litter treatments such as crusting, windrowing and pulverizing.

In a second mode of operation, water supply lines of the apparatus 2 and nipple drinker 8 are flushed between flock grow-out periods or as otherwise necessary to maintain a hygienic water supply. Referring once again to FIG. 1, in the case of a non-potable water supply 6, the apparatus 2 includes a bypass water line 44 including an isolation valve 46. To flush the water lines prior to new flock placement, the isolation valve 4b is opened, allowing pressurized, ozonated water to bypass the first and second reaction tanks 12, 20 and flow through the inline filter 26 and into the nipple drinker conduits 28. In the case of a potable water supply, the apparatus 2 connects flush water through the normal drinking water flow path 54. High volume flow for effective flushing of individual conduits is accomplished by opening a valve 48 at the end each conduit. Flush water is either collected in a portable container or directed outside the poultry facility through a temporary hose attachment.

At elevated temperatures found in a poultry housing unit, ozone has a short half-life. Subsurface ground temperatures are consistently well below the body temperature of chickens. In accordance with various aspects, the water supply line is preferably buried below the ground surface 50 to geothermally cool the water delivered to the nipple drinker conduits 28. Lower water temperatures improve weight gain, help regulate poultry body temperature and reduce flock heat stress. Furthermore, cooler water temperatures increase ozone half-life and improve pathogen reduction efficiency of the system. A supplemental geothermal cooling system may also be used to regulate water temperature within the nipple drinker conduits.

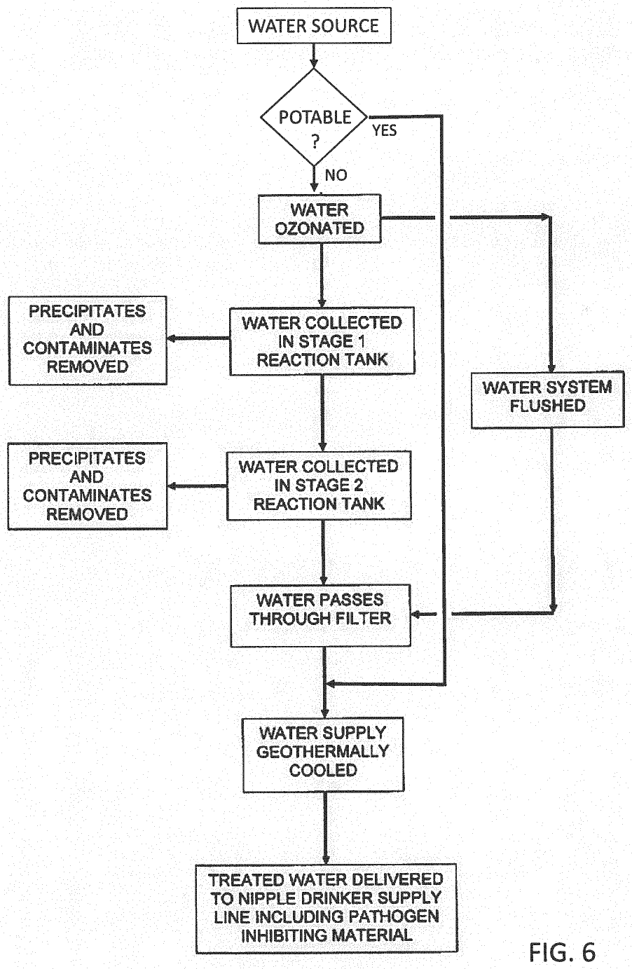

FIG. 6 is a flowchart depicting a method for delivering a hygienic water supply to a drinking water supply line. In a first stage of the method, water is drawn from either a non-potable source and ozonated or from a potable water source. In the case of a non-potable source, ozonated water is retained in a first reaction tank for a sufficient period to oxidize the biological and chemical contaminant load of the site-specific water supply. Once the desired oxidation is achieved, precipitates and disinfection byproducts are removed from the first tank. Water then flows from the first tank to a second reaction tank where the process of oxidizing and removing precipitates and disinfection byproducts is repeated. Those skilled in the art will appreciate that the number of reaction tanks employed may vary according to the desired sanitation quality and biological and chemical contamination load of the site-specific water supply.

The ozone treated water next flows to a filter where residual suspended solids and disinfection byproducts are removed. Those skilled in the art will appreciate that the number and type of filters employed may vary according to the desired sanitation quality and biological and chemical contaminant load of the site-specific water supply.

Following the filtration step in the case of non-potable water source or delivery of water directly to the distribution system from the potable water source, the temperature is adjusted, by geothermal cooling.

The cooled and treated water is then delivered to nipple drinker conduits filled with copper mesh for further treatment to prevent the formation of biofilm and development of pathogens in the water supply. The treated and sanitized water is then delivered to the poultry flock via the nipple drinker.

The water supply system and nipple drinkers are cleaned after to removal of a mature flock and prior to placement of a new flock. In the case of a non-potable water source, ozonated water bypasses the reaction tanks via a bypass line and the system water supply lines are flushed with a high flow of pressurized water to remove debris and particulate matter. In the case of drinking water from a potable source, water supply lines are similarly flushed with high flow pressurized water to remove debris and particulate matter.

While the present disclosure has been described with reference to one or more embodiments, those skilled in the art will recognize that many changes, including application for husbandry for other food animal types, may be made thereto without deputing from the spirit and scope of the present invention. Furthermore, components from one embodiment can be used in other non-exclusive embodiments. Each of those embodiments and obvious variations thereof is contemplated as falling within the spirit and scope of the invention.

1. Apparatus for providing hygienic drinking water to a poultry/animal husbandry facility, comprising:
(a) a nipple drinker assembly including at least one water supply conduit and at least one nipple drinker connected with said water supply conduit to deliver water to one of a poultry flock and unit of food animal production;
(b) an ozone generator connected with said nipple drinker assembly for adding ozone to the non-potable drinking water supply to oxidize contaminants and an perform as the primary sanitizing agent for drinking water; and
(c) a pathogen inhibiting material arranged within said water supply conduit, said material performing as the secondary sanitizing agent and preventing the formation a biofilm in the drinking water being supplied to the flock.

2. Apparatus as defined in claim 1, wherein said pathogen inhibiting material comprises at least one of copper and copper alloy mesh that maximizes drinking water surface contact without restricting water flow within said water supply conduit.

3. Apparatus as defined in claim 2, wherein said copper mesh extends continuously and provides effective contact surface throughout an internal cross section of a length of said water supply conduit.

4. Apparatus as defined in claim 3, and further comprising at least one filter arranged between said ozone generator and said nipple drinker assembly to filter the drinking water before it enters the nipple drinker assembly.

5. Apparatus as defined in claim 4, and further comprising at least one reaction tank arranged between said ozone generator and said nipple drinker assembly, the drinking water being retained in said reaction tank for a period sufficient for oxidizing dissolved metals and other contaminates, said filter being arranged between said reaction tank and said nipple drinker assembly.

6. Apparatus as defined in claim 5, and further comprising a bypass water supply line assembly arranged between said ozone generator and said nipple drinker assembly to deliver a flow of pressurized ozonated water to said nipple drinker assembly that removes mineral and biological debris from said water supply conduit and delivers elevated concentrations of ozone to said water supply conduit to clean the surface of said pathogen inhibiting material.

7. Apparatus as defined in claim 5, and further comprising a geothermal cooling system arranged between said filter and said nipple drinker assembly to regulate the temperature of the drinking water supplied to said nipple drinker assembly.

8. Apparatus for providing hygienic drinking water to a poultry/animal husbandry facile comprising:
(a) a potable water supply;
(b) a nipple drinker assembly including at least one water supply conduit and at least one nipple drinker connected with said water supply conduit to deliver water to one of a poultry flock and unit of food animal production; and
(c) a pathogen inhibiting material arranged within said water supply conduit, said material performing as the secondary sanitizing agent and preventing the formation of biofilm in the drinking water being supplied to the flock,

9. A method for providing hygienic drinking water to a nipple drinker assembly of a poultry/animal husbandry facility, comprising the steps of:
(a) adding ozone to drinking water to sanitize the drinking water and oxidize iron and other dissolved metals and other contaminants before it is delivered to the nipple drinker assembly; and
(b) inserting a pathogen inhibiting material within the nipple drinker assembly to prevent the propagation of pathogens and formation of biofilm in the drinking water supplied to a poultry flock within the facility, the ozone further maintaining surface cleanliness of the pathogen inhibiting material within the nipple drinker assembly.

10. A method as defined in claim 9, wherein said insertion step comprises arranging copper mesh within a nipple drinker water supply conduit.

11. A method as defined in claim 10, wherein the retrofit installation of copper mesh extends continuously and provides effective contact surface throughout internal cross section along a length the water supply conduit.

12. A method as defined in claim 11, and further comprising the step of filtering the drinking water after said adding ozone step.

13. A method as defined in claim 12, and further comprising the step of retaining the drinking water in a reaction tank after said adding ozone step and before said filtering step for a period of time sufficient to precipitate contaminates from the drinking water.

14. A method as defined in claim 11, and further comprising the step of adjusting the temperature of the drinking water to a desired degree prior to delivery of the drinking water to the nipple drinker assembly.

15. A method for retrofitting a water nipple drinker assembly of a poultry husbandry facility, comprising the steps of inserting a pathogen inhibiting material into a water supply conduit of the nipple drinker assembly without removing or disturbing individual nipple drinkers, the pathogen inhibiting material extending continuously and providing effective contact surface throughout internal cross section along a length the conduit to maximize drinking water surface contact without restricting water flow within said water supply conduit.

16. A method as defined in claim 15, wherein said pathogen inhibiting material is an engineered mesh of one of copper and copper alloy material.
